(19) United States
(12) Patent Application Publication
(10) Pub. No.: US 2014/0333848 A1
(43) Pub. Date: Nov. 13, 2014

(54) TOUCH ELECTRODE DEVICE

(71) Applicant: HengHao Technology Co. LTD, Taoyuan County (TW)

(72) Inventor: CHI-AN CHEN, Taipei City (TW)

(73) Assignee: HengHao Technology Co. LTD, Taoyuan County (TW)

(21) Appl. No.: 13/966,192

(22) Filed: Aug. 13, 2013

(30) Foreign Application Priority Data
May 9, 2013 (TW) 102116452

(51) Int. Cl. G06F 3/044

(52) U.S. Cl. CPC G06F 3/044
USPC 349/12

(57) ABSTRACT

A touch electrode device includes a first photosensitive insulating layer, a second photosensitive insulating layer, a first electrode layer and a second electrode layer. The first electrode layer is disposed on a surface of the first photosensitive insulating layer, and the second electrode layer is disposed on a surface of the second photosensitive insulating layer. Another surface of the photosensitive insulating layer is adhered to another surface of the second photosensitive insulating layer. Furthermore, each of the first electrode layer and the second electrode layer includes a non-transparent conductive material.

### CROSS-REFERENCE TO RELATED APPLICATIONS

The entire contents of Taiwan Patent Application No. 102116452, filed on May 9, 2013, from which this application claims priority, are incorporated, herein by reference.

### BACKGROUND OF THE INVENTION

1. Field of the Invention

The present invention generally relates to a touch panel, and more particularly to a touch electrode device with the double-layer electrode configuration.

2. Description of Related Art

A touch screen is an input/output device that adopts sensing technology and display technology, and. has been widely employed in electronic devices such as portable or hand-held electronic devices.

A capacitor-based touch panel is a commonly used touch panel that utilizes capacitive coupling effect to detect touch position. Specifically, capacitance corresponding to the touch position changes and is thus detected, when a finger touches a surface of the touch panel.

FIG. 1 shows a cross-sectional view of a conventional electrode device 100. As shown in FIG. 1, a first electrode layer 12 is disposed on a top surface of a substrate 10, and the first electrode layer 12 is adhered to a cover glass 16 by a first isolating layer 13. A second electrode layer 14 is adhered to a bottom surface of the substrate 10 by a second isolating layer 15. The first electrode layer 12 and the second electrode layer 14 may be substantially orthogonal to each other. Furthermore, the conventional electrode device 100 may also include a protective film 18 disposed on a bottom surface of the second electrode layer 14.

However, the thickness of each of the substrate 10, the first isolating layer 13 and the second isolating layer 15 in the conventional electrode device 100 is usually at least greater than 100 micrometers, so that the overall thickness of the electrode device 100 would be too large for the thin and light weight application. Moreover, the manufacturing process of the conventional electrode device 100 is so complicated that it would result in a high manufacturing cost.

For the reason that the conventional touch panel requires complex manufacturing process and cannot afford to make a thin touch panel, a need has thus arisen to propose a novel touch electrode device to overcome disadvantages of the conventional touch panels.

### SUMMARY OF THE INVENTION

In view of the foregoing, it is an object of the embodiment of the present invention to provide a touch electrode device with the simplified manufacturing process, so as to achieve the thinning effect and also decrease the manufacturing cost.

According to one embodiment of the present invention, a touch electrode device includes a first photosensitive insulating layer, a second photosensitive insulating layer, a first electrode layer and a second electrode layer. The first electrode layer is formed on a surface of the first photosensitive insulating layer, and the second electrode layer is formed on a surface of the second photosensitive insulating layer. Another surface of the first photosensitive insulating layer is adhered to another surface of the second photosensitive insulating layer. Each of the first electrode layer and the second electrode layer includes a non-transparent conductive material.

### BRIEF DESCRIPTION OF THE DRAWINGS

FIG. 1 shows a cross-sectional view of a conventional electrode device;

FIG. 2A shows a cross-sectional view of a touch electrode device according to one embodiment of the present invention;

FIG. 2B shows a manufacturing process of the touch electrode device in FIG. 2A; and

FIG. 2C shows a cross-sectional view of a touch electrode device according to another embodiment of the present invention.

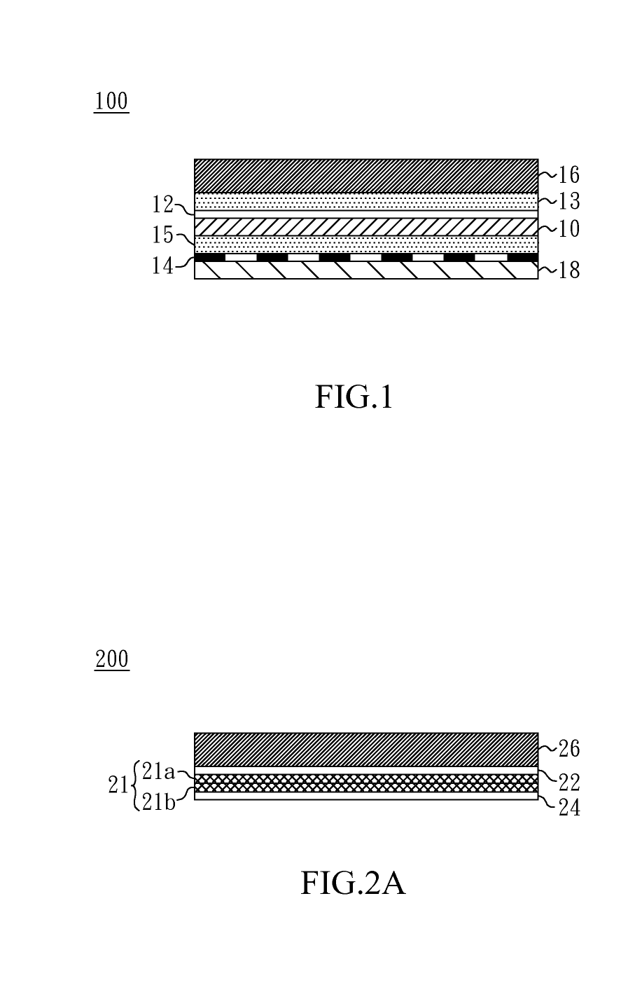

### DETAILED DESCRIPTION OF THE INVENTION

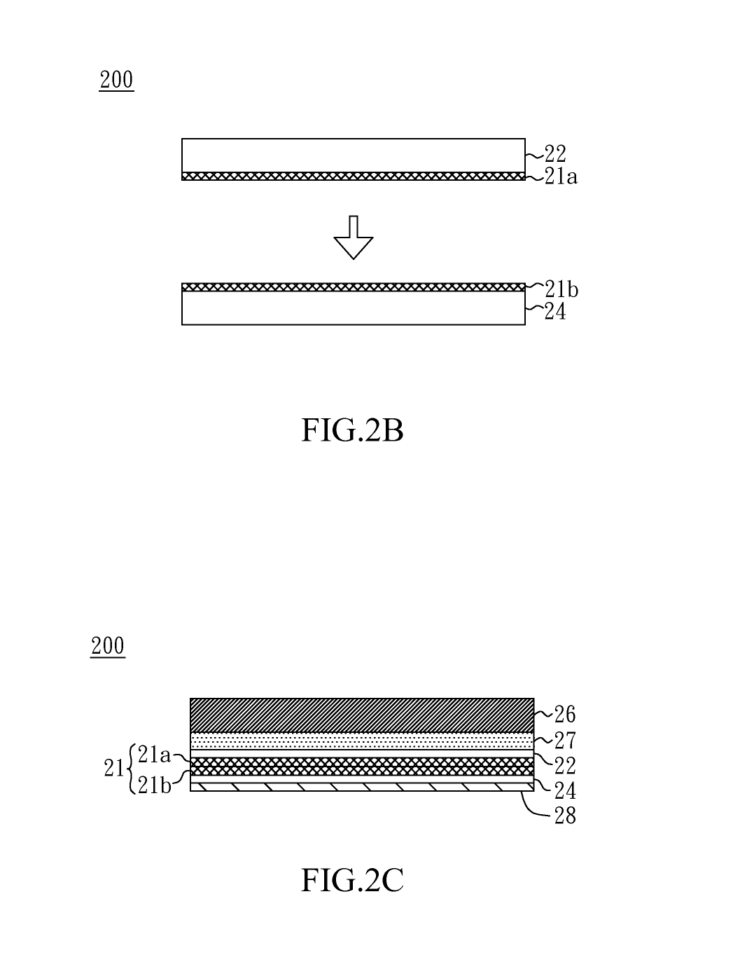

Referring to FIG. 2A and FIG. 2B, FIG. 2A shows a cross-sectional view of a touch electrode device 200 according to one embodiment of the present invention and FIG. 2B shows a manufacturing process of the touch electrode device in FIG. 2A. Only composing elements pertinent to the embodiment are shown in the figures. The touch electrode device 200 of the embodiment mainly includes a first photosensitive insulating layer 21a, a second photosensitive insulating layer 21b, a first electrode layer 22 and a second electrode layer 24. The first electrode layer 22 is formed on a surface of the first photosensitive insulating layer 21a, and the second electrode layer 24. is formed on a surface of the second photosensitive insulating layer 21b. Another surface of the first photosensitive insulating layer 21a is adhered to another surface of the second photosensitive insulating layer 21b. Each of the first electrode layer 22 and the second electrodelayer 24 includes a non-transparent conductive material.

Specifically, each of the first photosensitive insulating layer 21a and the second photosensitive insulating layer 21b has an adhesive surface. After the first electrode layer 22 and the second electrode layer are respectively formed on the first photosensitive insulating layer 21a and the second photosensitive insulating layer 21b, the first photosensitive insulating layer 21a. and the second photosensitive insulating layer 21b may be adhered to each other by the adhesive surfaces of the first photosensitive insulating layer 21a and the second photosensitive insulating layer 21b, so that a photosensitive insulating layer 21 may be formed, and the first electrode layer 22 and the second electrode layer 24 may respectively be disposed on the opposite surfaces of the photosensitive insulating layer 21. Therefore, the process steps and the manufacturing elements may be simplified to reduce the manufacturing cost greatly. Furthermore, as the thickness of the first photosensitive insulating layer 21a and the second photosensitive insulating layer 21b may be between 10 and 30 micrometers, therefore the thickness of the photosensitive insulating layer 21 may be between 20 and 60 micrometers. Accordingly, the overall thickness of the touch electrode device 200 can be decreased.

Furthermore, the first photosensitive insulating layer 21a and the second photosensitive insulating layer 21b may include a photosensitive isolating material, such that the photosensitive insulating layer not only can electrically isolate the first electrode layer 22 and the second electrode layer 24, but also can be employed in an exposure development process.

The first electrode layer 22 and the second electrode layer 24 may include a light-transmissive structure made of a non-transparent material. The non-transparent material may include metal nanowires (e.g., silver nanowires or copper nanowires) or metal nanonets (e.g., silver nanonets or copper nanonets). The metal nanowires or nanonets have a diameter in a nanometer order (i.e., a few nanometers to hundreds nanometers), and may be fixed in the first electrode layer 22 and the second electrode layer 24 via a plastic material (e.g., resin). Due to fineness of the metal nanowires/nanonets unobservable to human eyes, the first electrode layer 22 and the second electrode layer made of the metal nanowires/nanonets thus have high light-transmittance, and the overall thickness of the touch electrode device 200 may also be decreased. As the metal nanowires/nanonets are flatly distributed, the first electrode layer 22 and the second electrode layer 24 made of the metal nanowires/nanonets have an isotropic conductivity, which is substantially invariant with respect to direction.

However, according to the embodiment, the first electrode layer 22 and the second electrode layer 24 may further include a photosensitive material (e.g., acrylic), through which electrodes with a required pattern may be formed via an exposure development process, so that the process steps and the equipment may be simplified efficiently to eliminate redundancy.

Moreover, the touch electrode device 200 may further include a cover glass 26. The first electrode layer 22, the photosensitive insulating layer 21 and the second electrode layer 24 are disposed on a bottom surface of the cover glass 26 in sequence. The cover glass 26 shown in FIG. 2A may have a two-dimensional or three-dimensional profile, which may be applied to a two-dimensional or a three-dimensional touch display, respectively. In one embodiment, the cover glass 26 may include a flexible material or a rigid material, and the surface material of the cover glass 26 may be treated to have anti-wear, anti-scratch, anti-reflection, anti-glare and anti-fingerprint features.

Referring to FIG. 2C, in another embodiment, the touch electrode device 200 may further include an isolating layer 27, which is disposed between the cover glass 26 and the first electrode layer 22. The isolating layer 27 may include optically clear adhesive (OCA) or silicon dioxide. The isolating layer 27 may further include a photosensitive material, through which a required pattern may be formed via an exposure development process. Furthermore, the touch electrode device 200 may also include a protective film 28 disposed on a bottom surface of the second electrode layer 24, so as to cover the second electrode layer 24 and provide a protective effect of being electrically isolated.

Although specific embodiments have been illustrated and described, it will be appreciated by those skilled in the art that various modifications may be made without departing from the scope of the present invention, which is intended to be limited solely by the appended claims.

What is claimed is:

1. A touch electrode device, comprising:
a first photosensitive insulating layer;
a second photosensitive insulating layer;
a first electrode layer formed on a surface of the first photosensitive insulating layer; and
a second electrode layer formed on a surface of the second photosensitive insulating layer;
wherein another surface of the first photosensitive insulating layer is adhered to another surface of the second photosensitive insulating layer, and each of the first electrode layer and the second electrode layer comprises a non-transparent conductive material.

2. The touch electrode device of claim 1 wherein each of the first photosensitive insulating layer and the second photosensitive insulating layer has an adhesive surface.

3. The touch electrode device of claim 1, wherein each of the first photosensitive insulating layer and the second photosensitive insulating layer has a thickness of between 10 and 30 micrometers.

4. The touch electrode device of claim 1, wherein each of the first photosensitive insulating layer and the second photosensitive insulating layer comprises a photosensitive isolating material.

5. The touch electrode device of claim 1, wherein the first electrode layer or the second electrode layer comprises a light-transmissive structure made of a non-transparent material.

6. The touch electrode device of claim 5, wherein the non-transparent conductive material comprises a plurality of metal nanowires or metal nanonets.

7. The touch electrode device of claim 6, wherein the metal nanowires or the metal nanonets have a diameter of some nanometers to hundreds of nanometers.

8. The touch electrode device of claim 6, wherein the metal nanowires or the metal nanonets are flatly distributed.

9. The touch electrode device of claim 6, wherein the first electrode layer and the second electrode layer further comprise a plastic material for fixing the non-transparent conductive material in the first electrode layer and the second electrode layer.

10. The touch electrode device of claim 1, wherein each of the first electrode layer and the second electrode layer comprises a photosensitive material.

11. The touch electrode device of claim 1, wherein the touch electrode device further comprises a cover glass, and the first electrode layer is disposed on a bottom surface of the cover glass.

12. The touch electrode device of claim 11, wherein the cover glass comprises a flexible material or a rigid material.

13. The touch electrode device of claim 11, wherein the touch electrode device further comprises an isolating layer disposed between the first electrode layer and the cover glass.

14. The touch electrode device of claim 13, wherein the isolating layer comprises optically clear adhesive (OCA) or silicon dioxide.

15. The touch electrode device of claim 13, wherein the isolating layer further comprises a photosensitive material.

16. The touch electrode device of claim 1, wherein the isolating layer further comprises a protective film disposed on a bottom surface of the second electrode layer.
